(19) United States
(12) Patent Application Publication
(10) Pub. No.: US 2024/0211035 A1
(43) Pub. Date: Jun. 27, 2024

(54) FOCUS ADJUSTMENTS BASED ON ATTENTION

(71) Applicant: Apple Inc., Cupertino, CA (US)

(72) Inventors: Arthur Y. Zhang, San Jose, CA (US); Ray L. Chang, Saratoga, CA (US); Yanli Zhang, Los Altos, CA (US); Luke A. Pillans, San Diego, CA (US); Ryan J. Dunn, Santa Cruz, CA (US); Jeffrey N. Gleason, San Francisco, CA (US); Christian Moore, Sunnyvale, CA (US); Simon Fortin-Deschenes, Santa Clara, CA (US); Emmanuel Piuze-Phaneuf, Los Gatos, CA (US)

(21) Appl. No.: 18/390,084

(22) Filed: Dec. 20, 2023

Related U.S. Application Data
(60) Provisional application No. 63/434,722, filed on Dec. 22, 2022.

(51) Int. Cl. G06F 3/01; G06F 1/16; H04N 23/62

(52) U.S. Cl. CPC G06F 3/013; G06F 1/163; H04N 23/62

(57) ABSTRACT

Various implementations disclosed herein include devices, systems, and methods that adjust a focus of a camera based on a distance associated with a determined user attention. For example, an example process may include obtaining sensor data from one or more sensors in a physical environment. The process may include determining at least one gaze direction of at least one eye based on the sensor data. The process may further include determining a distance associated with user attention based on a convergence determined based on an intersection of gaze directions of the at least one gaze direction, or a distance of an object in a 3D representation of the physical environment based on the at least one gaze direction. The process may further include adjusting a focus of a camera of the one or more sensors based on the distance associated with the user attention.

### CROSS-REFERENCE TO RELATED APPLICATIONS

This application claims the benefit of U.S. Provisional Application Ser. No. 63/434,722 filed Dec. 22, 2022, each of which is incorporated by reference herein in its entirety.

### TECHNICAL FIELD

The present disclosure generally relates to electronic devices, and in particular, to systems, methods, and devices for detecting a distance associated with an attention of users of electronic devices.

### BACKGROUND

Existing techniques for adjusting a focus of a view based on what a user is looking at may adjust a lens or the content of a display of an electronic device. Some electronic devices may lack accuracy on determining a depth of the viewer's gaze and be able to track the user's gaze depth in real-time in order to adjust the focus. Thus, it may be desirable to provide a means of efficiently determining precisely which part of the scene (which distance, or “depth”) the user is concentrated on for assessing an eye characteristic (e.g., gaze direction, eye orientation, identifying an iris of the eye, etc.) towards an object to adjust a focus of an external facing camera for electronic devices, such as head mountable systems.

### SUMMARY

Some implementations disclosed herein provide systems and methods for adjusting focus of an outward-facing camera (e.g., for a head mounted system) based on one or more input methods to determine what an eye is attending to (e.g., focus/vergence). In some implementations, virtual content clarity may be adjusted to match the camera content. In some implementations, the focus adjustments are provided in real-time as the user is viewing a pass-through-based extended reality (XR) experience.

In some implementations, an input method may include an analysis of a scene of an environment through a depth map, saliency map, and the like. In some implementations, an input method may include sensor data of a user such as tracking gaze, head pose, user motion, etc. For example, the adjusted focus may be based on biasing the focus depending on user behavior (e.g., if the user is walking around, the system may want to bias the focus to a longer distance, or if the user is seated, surrounded by close objects, the system may want to bias closer focus). In some implementations, an input method may be based on the digital content (e.g., rendered content) and/or be application specific (e.g., application specific control of focus). For example, a productivity application, where the user is expected to work with objects close to them (e.g., seated at a desk and using keyboard and mouse) the application behavior may control the focus to be closer, or if the application is an archery application, the system may bias the focus to a further distance).

The automatic adjustment process described herein may utilize an open-loop process and/or a closed-loop process, as described herein. For example, an open-loop process, sometimes referred to herein as a “feedforward process”, may focus on a particular object, and have the camera focus at a distance (e.g., user attention distance) based on a depth map and a persistent world model, vergence angles from pupils, etc. This open-loop process may be faster and more efficient for processing and avoid overshoot and focus rocking during the adjustment phase. A closed-loop process, sometimes referred to herein as a “feedback process”, may adjust a focus of an external-facing or an outward-facing camera based on where the user is looking on a display of a head mounted system (e.g., a user attention vector). The closed-loop process may identify a corresponding object and a depth of the corresponding object based on depth sensor data. Thus, as opposed to determining a distance based on focus information provided by the camera itself, the closed-loop process may be different because the closed-loop process is based on where the user is looking on a display, and not based on the camera focus information.

In general, one innovative aspect of the subject matter described in this specification can be embodied in methods, at an electronic device having a processor, a display, and one or more sensors, that include the actions of obtaining sensor data from the one or more sensors in a physical environment, determining at least one gaze direction of at least one eye based on the sensor data, determining a distance associated with user attention based on: (a) a convergence determined based on an intersection of gaze directions of the at least one gaze direction, or (b) a distance of an object in a 3D representation of the physical environment based on the at least one gaze direction and a characteristic of the physical environment based on the sensor data, and adjusting a focus of a camera of the one or more sensors based on the distance associated with the user attention, the camera capturing image data of the physical environment that is displayed on the display.

These and other embodiments can each optionally include one or more of the following features.

In some aspects, determining the distance associated with user attention is based on the convergence determined based on the intersection of the gaze direction. In some aspects, determining the distance associated with user attention is based on detecting that a first gaze direction of the at least one gaze direction is oriented towards an object or an area in the 3D representation. In some aspects, determining the distance associated with user attention is based on different types of data obtained by the one or more sensors.

In some aspects, the different types of data include at least one of gaze vector data, depth map data, gaze convergence data, or user interface content.

In some aspects, the user attention is determined by obtaining a scene understanding that identifies one or more objects and positions of the one or more objects within the physical environment, and determining user attention based on a gaze associated with a particular object of the one or more objects within the physical environment.

In some aspects, the at least one gaze direction is determined based on a reflective property associated with infrared (IR) reflections on the at least one eye.

In some aspects, the display presents an extended reality (XR) environment based at least in part on the physical environment, wherein clarity of virtual content in the XR environment is adjusted to match the image data captured by the camera.

In some aspects, the electronic device is a head-mounted device (HMD).

In general, one innovative aspect of the subject matter described in this specification can be embodied in methods, at an electronic device having a processor, a display, and one or more sensors, that include the actions of obtaining, while presenting an extended reality (XR) environment, sensor data from the one or more sensors in a physical environment; determining a gaze direction of at least one eye based on the sensor data during the presenting of the XR environment, identifying a displayed object based on the gaze direction relative to the display; and determining a distance associated with user attention based on a distance of an object in the physical environment corresponding to the displayed object, the distance of the object in the physical environment determined based on depth sensor data or image-based distance computation, and adjusting a focus of a camera of the one or more sensors based on the distance associated with the user attention, the camera capturing image data of the physical environment that is displayed on the display.

These and other embodiments can each optionally include one or more of the following features.

In some aspects, the distance of the object in the physical environment is determined based on depth sensor data. In some aspects, the distance of the object in the physical environment is determined based on image-based distance computation.

In some aspects, determining the distance associated with user attention is based on different types of data obtained by the one or more sensors.

In some aspects, the different types of data include at least one of gaze vector data, depth map data, gaze convergence data, or user interface content.

In some aspects, determining the distance associated with user attention is based on obtaining a scene understanding that identifies one or more objects and positions of the one or more objects within the physical environment, and determining user attention based on a gaze associated with a particular object of the one or more objects within the physical environment.

In some aspects, the gaze direction is determined based on a reflective property associated with infrared (IR) reflections on the at least one eye.

In some aspects, clarity of virtual content in the XR environment is adjusted to match the image data captured by the camera.

In some aspects, the user attention is determined based on display characteristics or display settings associated with the display of the electronic device.

In some aspects, the display includes a liquid lens. In some aspects, the display includes a light field display. In some aspects, the electronic device is a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example of a device used within a physical environment in accordance with some implementations.

FIGS. 2A and 2B illustrate example views provided by the device of FIG. 1, the views including a left eye view and a right eye view in accordance with some implementations.

FIG. 2C illustrates a view of a gaze for the left eye view and the right eye view of FIGS. 2A and 2B, respectively, and a corresponding convergence angle, in accordance with some implementations.

FIG. 3 illustrates a system flow diagram of a user attention assessment to adjust the focus of a camera based on a determined distance associated with the user attention in accordance with some implementations.

FIGS. 4A and 4B illustrate example views provided by the device of FIG. 1 with adjusted focus of a camera based on user attention, in accordance with some implementations.

FIG. 5 is a flowchart representation of an exemplary method that adjusts the focus of a camera based on a determined distance associated with user attention in accordance with some implementations.

FIG. 6 is a flowchart representation of an exemplary method that adjusts the focus of a camera based on a determined distance associated with user attention while presenting an extended reality (XR) environment in accordance with some implementations.

FIG. 7 is an example electronic device in accordance with some implementations.

FIG. 8 illustrates an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous specific details are provided herein to afford those skilled in the art a thorough understanding of the claimed subject matter. However, the claimed subject matter may be practiced without these details. In other instances, methods, apparatuses, or systems, that would be known by one of ordinary skill, have not been described in detail so as not to obscure claimed subject matter.

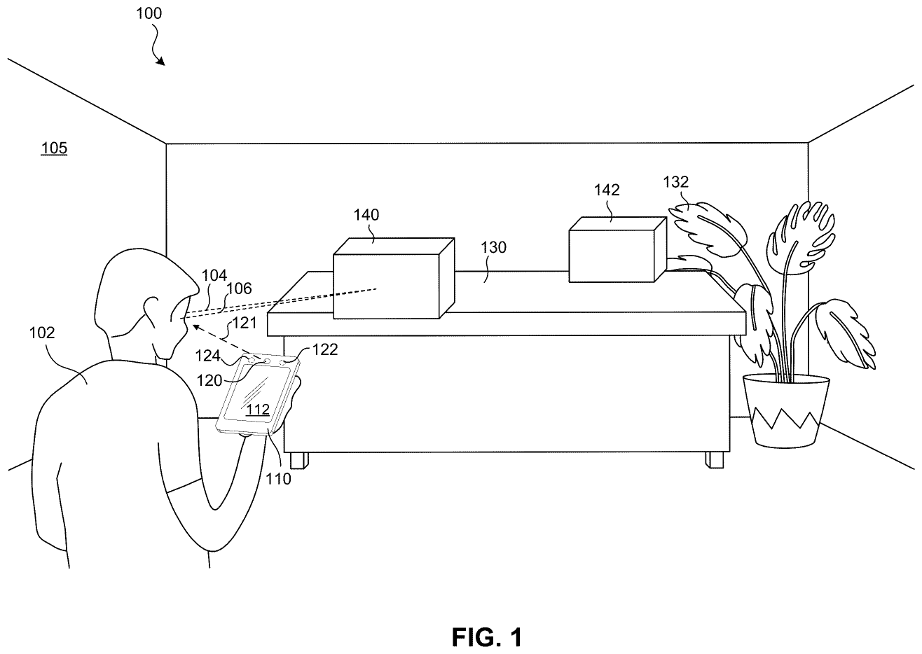

FIG. 1 illustrates an exemplary operating environment 100 in accordance with some implementations. In this example, the example operating environment 100 involves an exemplary physical environment 105 that includes physical objects such as desk 130, plant 132, a first object 140, and a second object 142. Additionally, physical environment 105 includes user 102 holding device 110. As illustrated, a gaze of the user 102 is towards the first object 140, which happens to be closer (e.g., a different depth) to the user 102 (e.g., on top of and towards the front of the desk 130) than the second object (e.g., located more towards the back of the desk 130). The gaze of the user 102 is illustrated as a left eye gaze 104 and right eye gaze 106 as may be detected by sensor 120. In some implementations, the device 110 is configured to present a computer-generated environment to the user 102 on a display 112. The presented environment can include extended reality (XR) features.

In some implementations, the device 110 is a handheld electronic device (e.g., a smartphone or a tablet). In some implementations, the device 110 is a near-eye device such as a head worn device. The device 110 utilizes one or more display elements to present views. For example, the device 110 can display views that include content in the context of an extended reality environment. In some implementations, the device 110 may enclose the field-of-view of the user 102. In some implementations, the functionalities of device 110 are provided by more than one device. In some implementations, the device 110 communicates with a separate controller or server to manage and coordinate an experience for the user. Such a controller or server may be located in or may be remote relative to the physical environment 105.

In some implementations, content displayed by the device 110 may be a visual 3D environment (e.g., an XR environment), and visual characteristics of the 3D environment may continuously change. Inertial head pose measurements may be obtained by the IMU or other tracking systems. In one example, a user can perceive a real-world environment while holding, wearing, or being proximate to an electronic device that includes one or more sensors that obtains physiological data to assess an eye characteristic that is indicative of the user's gaze characteristics, and motion data of a user.

In some implementations, a visual characteristic is displayed as a feedback mechanism for the user that is specific to the views of the 3D environment (e.g., a visual or audio cue presented during the viewing). In some implementations, viewing the 3D environment can occupy the entire display area of display. For example, the content displayed may be a sequence of images that may include visual and/or audio cues presented to the user (e.g., 360-degree video on a head mounted device (HMD)).

The device 110 obtains physiological data (e.g., pupillary data) from the user 102 via a sensor 120. For example, the device 110 obtains eye gaze characteristic data 121 via sensor 120. In particular, as illustrated in FIG. 1, the user 102 has focused his or her gaze (e.g., left eye gaze 104 and right eye gaze 106) eye gaze characteristic data 121 on the first object 140. While this example and other examples discussed herein illustrate a single device 110 in a real-world environment 105, the techniques disclosed herein are applicable to multiple devices as well as to other real-world environments. For example, the functions of device 110 may be performed by multiple devices.

In some implementations, as illustrated in FIG. 1, the device 110 is a handheld electronic device (e.g., a smartphone or a tablet). In some implementations, the device 110 is a wearable HMD. In some implementations the device 110 is a laptop computer or a desktop computer. In some implementations, the device 110 has a touchpad and, in some implementations, the device 110 has a touch-sensitive display (also known as a “touch screen” or “touch screen display”).

In some implementations, the device 110 includes sensors 122 and 124, located on the back of the device 110, for acquiring image data of the physical environment (e.g., as the user 102 views the environment). The image data can include light intensity image data and/or depth data. For example, sensor 122 may be a video camera for capturing RGB data, and sensor 124 may be a depth sensor (e.g., a structured light, a time-of-flight, or the like) for capturing depth data. The image sensors 122, 124, and the like, may include a first light intensity camera that acquires light intensity data for the left eye viewpoint and a second light intensity camera that acquires light intensity data for the right eye viewpoint of the physical environment. Additionally, the image sensors 122, 124, and the like, may include a first depth camera that acquires depth image data for the left eye viewpoint and a second depth camera that acquires depth image data for the right eye viewpoint of the physical environment. Alternatively, one depth sensor is utilized for both depth image data for the left eye viewpoint and the right eye viewpoint. Thus, the depth data is equivalent. Alternatively, the depth data can be determined based on the light intensity image data, thus not requiring a depth sensor.

In some implementations, the device 110 includes an eye tracking system for detecting eye position and eye movements (e.g., eye gaze characteristic data 121). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 102 (e.g., via sensor 120). Moreover, the illumination source of the device 110 may emit NIR light to illuminate the eyes of the user 102 and the NIR camera may capture images of the eyes of the user 102. In some implementations, images captured by the eye tracking system may be analyzed to detect position and movements of the eyes of the user 102, or to detect other information about the eyes such as pupil dilation or pupil diameter. Moreover, the point of gaze estimated from the eye tracking images may enable gaze-based interaction with content shown on the display of the device 110.

In some implementations, the device 110 has a graphical user interface (GUI), one or more processors, memory and one or more modules, programs or sets of instructions stored in the memory for performing multiple functions. In some implementations, the user 102 interacts with the GUI through finger contacts and gestures on the touch-sensitive surface. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 110 employs various physiological sensor, detection, or measurement systems. In an exemplary implementation, detected physiological data includes inertial head pose measurements determined by an IMU or other tracking systems. In some implementations, detected physiological data may include, but is not limited to, electroencephalography (EEG), electrocardiography (ECG), electromyography (EMG), functional near infrared spectroscopy signal (fNIRS), blood pressure, skin conductance, or pupillary response. Moreover, the device 110 may simultaneously detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, the location and features of the head of the user 102 (e.g., an edge of the eye, a nose or a nostril) are extracted by the device 110 and used in finding coarse location coordinates of the eyes of the user 102, thus simplifying the determination of precise eye features (e.g., position, gaze direction, etc.) and making the gaze characteristic(s) measurement more reliable and robust. Furthermore, the device 110 may readily combine the 3D location of parts of the head with gaze angle information obtained via eye part image analysis in order to identify a given on-screen object at which the user 102 is looking at any given time. In some implementations, the use of 3D mapping in conjunction with gaze tracking allows the user 102 to move his or her head and eyes freely while reducing or eliminating the need to actively track the head using sensors or emitters on the head.

By tracking the eyes, some implementations reduce the need to re-calibrate the user 102 after the user 102 moves his or her head. In some implementations, the device 110 uses depth information to track the pupil's movement, thereby enabling a reliable present pupil diameter to be calculated based on a single calibration of user 102. Utilizing techniques such as pupil-center-corneal reflection (PCCR), pupil tracking, and pupil shape, the device 110 may calculate the pupil diameter, as well as a gaze angle of the eye from a fixed point of the head, and use the location information of the head in order to re-calculate the gaze angle and other gaze characteristic(s) measurements (e.g., measuring a convergence gaze angle from the user 102 to the first object 140 and an associated attention distance to the first object). In addition to reduced recalibrations, further benefits of tracking the head may include reducing the number of light projecting sources and reducing the number of cameras used to track the eye.

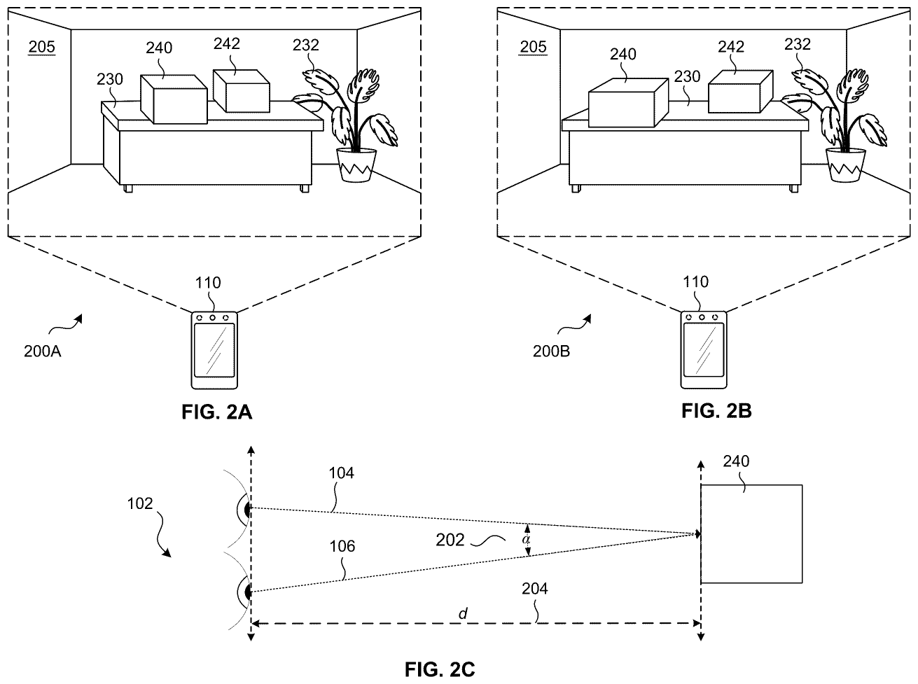

FIGS. 2A and 2B illustrate exemplary views provided by the display elements of device 110. The views present a 3D environment 205 that includes aspects of a physical environment (e.g., environment 105 of FIG. 1). In some implementations, the 3D environment 205 may partially include virtual content (e.g., an XR environment), or could be entirely virtual content (e.g., a mesh representation of the environment 105 of FIG. 1). Optionally, presenting the views of the 3D environment 205 includes presenting video pass-through or see-through images of at least a portion of a physical environment, wherein a 3D reconstruction of at least the portion of the physical environment is dynamically generated.

The 3D display data can be captured, stored, and/or displayed on the same or another device, e.g., on a device that has left eye and right eye displays for viewing stereoscopic images, such as an HMD. The first view 200A, depicted in FIG. 2A, provides a view of the physical environment 105 from a particular viewpoint (e.g., left-eye viewpoint) facing the desk 130. Accordingly, the first view 200A includes a representation 230 of the desk 130, a representation 232 of the plant 132, a representation 240 of the first object 140, and a representation 242 of the second object 142 from that viewpoint. The second view 200B, depicted in FIG. 2B provides a similar view of the physical environment 105 as illustrated in view 200A, but from a different viewpoint (e.g., right-eye viewpoint) facing a portion of the physical environment 105 slightly more towards the right of the first object 140 (e.g., the object of interest). The representations 240, 242, etc., are visible in the second view 200B, but at different locations (compared to the first view 205A) based on the different viewpoints (e.g., pupillary distance with respect to the convergence of the user's gaze upon an object of interest).

FIG. 2C illustrates a top-down view of a gaze for the left eye view and the right eye view of FIGS. 2A and 2B, respectively, and a corresponding convergence angle, in accordance with some implementations. In some implementations, determining an attention distance d 204 associated with user attention may be based on the convergence angle α 202 determined based on the intersection of the gaze direction. For example, as illustrated in FIG. 2C, as the user 102 directs his left eye gaze 104 and right eye gaze 106 at the first object 140 (or towards the representation 240 of the first object 140 if looking at a 3D representation of the physical environment), and the convergence angle α 202 of the left eye gaze 104 and right eye gaze 106 may be determined in order to determine the focus of the user is upon the first object. Thus, as further described herein, an external camera may automatically adjust the focus of the camera to accommodate to the attention distance d that the user is focused on, thus, when adding virtual content that is placed at that attention distance d, virtual content object would be shown as focused, but if the added virtual content was intended to be placed at a different distance than the attention distance d, it may be shown as out of focus of slightly blurred.

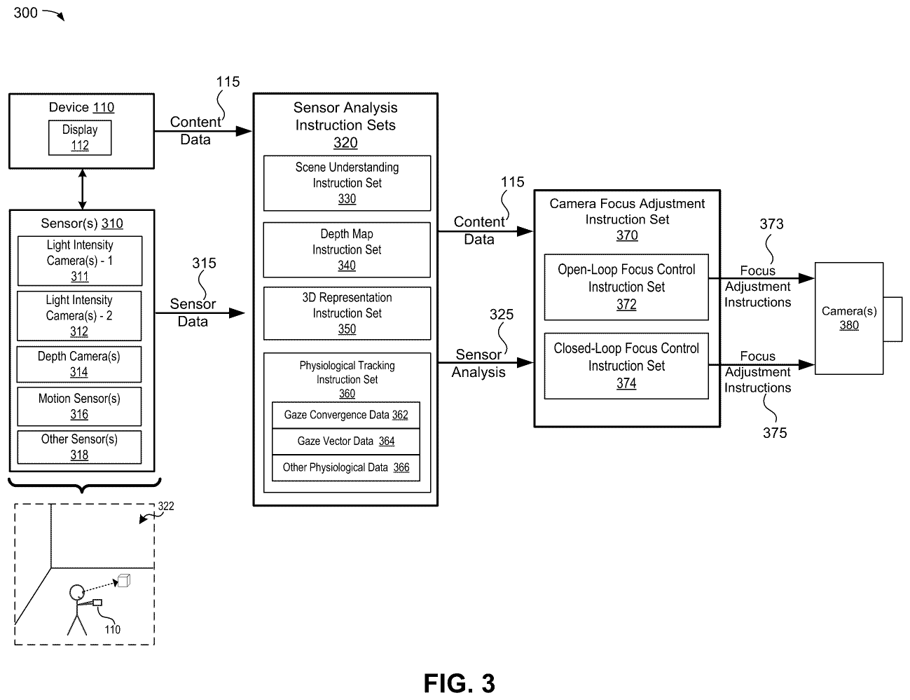

FIG. 3 illustrates a system flow diagram of user attention assessment to adjust a focus of a camera based on a determined distance associated with the user attention in accordance with some implementations. In some implementations, the system flow of the example environment 300 is performed on a device (e.g., device 110 of FIG. 1), such as a mobile device, desktop, laptop, or server device. In some implementations, the system flow of the example environment 300 is performed on processing logic, including hardware, firmware, software, or a combination thereof. In some implementations, the system flow of the example environment 300 is performed on a processor executing code stored in a non-transitory computer-readable medium (e.g., a memory).

In an example implementation, the environment 300 includes a sensor data pipeline that acquires or obtains data (e.g., image data from image source(s), depth data, motion data, etc.) for a physical environment (e.g., physical environments 105 of FIG. 1). Example environment 300 includes obtaining and providing content data 115 as provided on the display 112 of the device 110 (e.g., UI content). Additionally, example environment 300 is an example of acquiring image sensor data (e.g., light intensity data, depth data, and motion data) for a plurality of image frames and providing a view that adjusts a focus of an external camera based on user attention based on the sensor data. For example, as illustrated in example environment 322, a user (e.g., user 102) may be in a room acquiring sensor data from sensor(s) 310 while focusing on an object or area in the room for the view (e.g., representation 242 of the first object 142). The image source(s) may include one or more light intensity camera(s) 311, 312 (e.g., RGB cameras) that acquires light intensity image data (e.g., a sequence of RGB image frames). For example, the one or more light intensity camera(s)-1 311 may include the set of inward facing camera's (IFC) that acquire image data about the user for eye gaze characteristic data, facial movements, body movements, etc. (e.g., sensor 120 of FIG. 1), and the one or more light intensity camera(s)-2 312 may include one or more external and outward facing camera's that acquire image data about the external environment.

The sensor(s) 310 may further include one or more depth camera(s) that acquires depth data, a motion sensor 518 that acquires motion data, and additional sensors illustrated as one or more other sensors 318. The one or more depth camera(s) may determine a depth of an identified portion of a 3D environment. For example, a distance of the object from the capturing device (e.g., the distance from device 110 and the representation 242 of the first object 142 in FIG. 1, as illustrated by user attention distance d 204 in FIG. 2C). In some implementations, depth may be determined based on sensor data from a depth sensor on the capture device. In some implementations, depth of the identified portion of the 3D environment is determined based on the stereoscopic video. For example, depth information may be determined based on stereo RGB image data, thus not requiring a depth sensor. In some implementations, depth of the identified portion of the 3D environment is determined based on the stereoscopic video.

The one or more other sensors 318 may include location sensor(s) that acquires specific location data from location sensors/devices (e.g., location sensor(s)) such as WiFi/GPS data to determine an exact location, i.e., mapping data to determine whether the current environment is indoors or outdoors. The one or more other sensors 318 may include an ambient light sensor that acquires ambient light data (e.g., multiwavelength ALS data), UV/IR sensors (e.g., a UV and IR sensor that are joined together in a single apparatus, or a separate sensor for UV and IR) that acquires UV and IR data, and other data from other sensors.

For positioning information, some implementations include a VIO system to determine equivalent odometry information using sequential camera images (e.g., light intensity data from light intensity camera(s) 311, 312) to estimate the distance traveled. Alternatively, some implementations of the present disclosure may include a simultaneous localization and mapping (SLAM) system. The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 300 includes sensor analysis instruction sets 320 that are configured with instructions executable by a processor to obtain sensor data 315 from the one or more sensors 310 (e.g., light intensity data, depth data, motion data, etc.), obtain content data 115 from the device 110, and determine sensor analysis information 325 for the device using one or more of the techniques disclosed herein. For example, the sensor analysis information 325 may include different types of data may include at least one of gaze vector data, depth map data (e.g., passthrough, metric depth, rendered depth map, etc.), gaze convergence data, user interface content, or a combination thereof. The sensor analysis information 325 is sent to the camera focus adjustment instruction set 370. As illustrated in FIG. 3, the sensors 310 may acquire several different types of data that are analyzed by the sensor analysis instruction sets 320 and can be fused in several different combinations by the camera focus adjustment instruction set 370.

The sensor analysis instruction sets 320 may include a scene understanding instruction set 330 to determine a context of the experience and/or the environment (e.g., create a scene understanding to determine the objects or people in the content or in the environment, where the user is, what the user is watching, etc.) using one or more of the techniques discussed herein (e.g., object detection, facial recognition, etc.) or as otherwise may be appropriate.

The sensor analysis instruction sets 320 may include a depth map instruction set 340 to generate a map of depth data of a scanned environment (e.g., physical environment 105), to provide different signal characteristics compared to textured video data. A depth map may include depth-images, such as a saliency map, a 3D point cloud, and the like. The sensor analysis instruction sets 320 may further include a 3D representation instruction set 350 to generate a 3D representation of a scanned environment (e.g., physical environment 105), such as a 3D point cloud, a 3D mesh, a 3D floor plan, and/or a 3D room plan.

The sensor analysis instruction sets 320 may include a physiological tracking instruction set 360 to track one or more different types of physiological data such as gaze convergence data 362 (e.g., convergence angle α 202 of the left eye gaze 104 and right eye gaze 106), gaze vector data 364 (e.g., attention distance d), and other physiological data 366. For example, the physiological tracking instruction set 360 may acquire physiological data such as pupillary data and respiratory data from the user 102 viewing the content (e.g., content data 115). Additionally, or alternatively, a user 102 may be wearing a sensor such as an EEG sensor, an EDA sensor, heart rate sensor, etc. (e.g., as a wearable device, such as a smart watch) that generates sensor data (e.g., EEG data, respiratory data, EDA data, heart rate data, etc.) as additional physiological data. Thus, as the content data 115 is presented to the user, physiological data (e.g., pupillary data, such as gaze characteristic data 121) and/or other sensor data 315 is sent to the physiological tracking instruction set 360 to track a user's physiological attributes as physiological tracking data, using one or more of the techniques discussed herein or as otherwise may be appropriate. Alternatively, the physiological tracking instruction set 360 obtains physiological data associated with the user 102 from a physiological database (e.g., if the physiological data was previously analyzed by the physiological tracking instruction set, such as during a previously viewed/analyzed video that can then be used to adjust focus of a camera in a replayed video).

In an example implementation, the environment 300 includes a camera focus adjustment instruction set 370 that is configured with instructions executable by a processor to obtain sensor analysis information 325 from the sensor analysis instruction sets 320 and determine focus adjustment instructions using one or more of the techniques disclosed herein. For example, the camera focus adjustment instruction set 370 may include two different techniques: open-loop focus adjustment instruction set 372 and a closed-loop focus adjustment instruction set 374 that adjust a focus of an outward-facing camera (e.g., camera(s) 380, i.e., for a head mounted system) based on what an eye is attending to (e.g., focus/vergence). The open-loop focus adjustment instruction set 372 is configured with instructions executable by a processor to focus on a particular object, and have the camera focus at a distance (e.g., user attention distance) based on a depth map and a persistent world model, vergence angles from pupils, etc., and provide focus adjustment instructions 373 to the one or more external camera(s) 380. This open-loop process may be faster and more efficient for processing and avoid overshoot and focus rocking during the adjustment phase. The closed-loop focus adjustment instruction set 374 is configured with instructions executable by a processor to adjust a focus of an external camera based on where the user is looking on a display of a head mounted system (e.g., a user attention vector), and provide focus adjustment instructions 375 to the one or more external camera(s) 380. The closed-loop process may identify a corresponding object and a depth of the corresponding object based on depth sensor data. Thus, as opposed to determining a distance based on focus information provided by the camera itself for the technique of the open-loop focus adjustment instruction set 372, the closed-loop process for the closed-loop focus adjustment instruction set 374 may be different because the closed-loop process is based on where the user is looking on a display (e.g., a user attention vector and a camera focus region of interest), and not based on the camera focus information (e.g., user attention distance and camera focus distance) of the open-loop process.

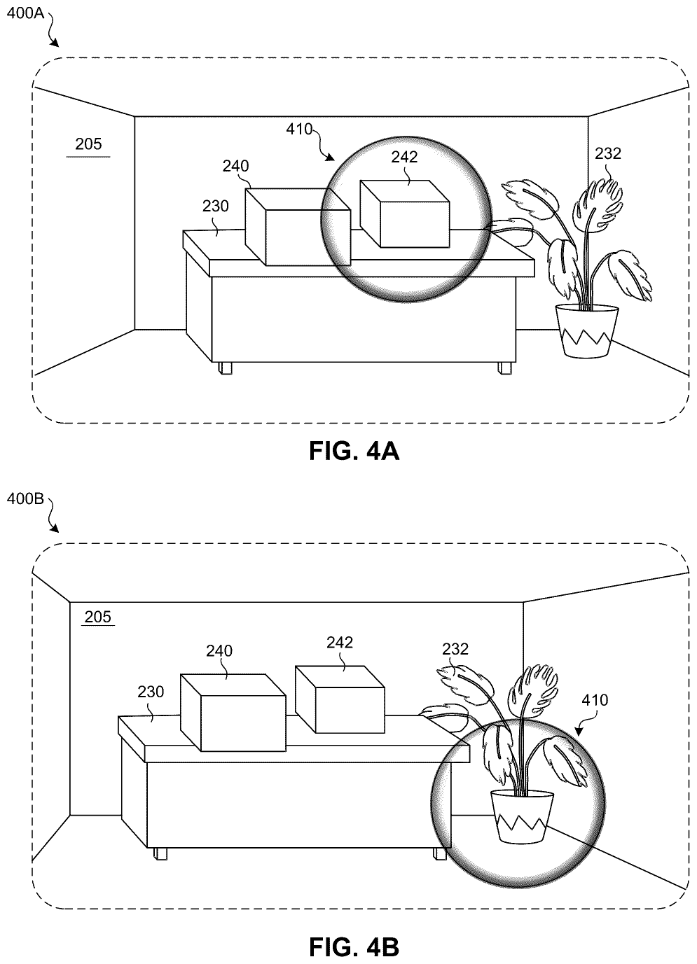

FIGS. 4A and 4B illustrate example views 400A, 400B, respectively, provided by the device of FIG. 1 with adjusted focus of a camera based on user attention, in accordance with some implementations. In particular, views 400A, 400B include a focus element 410 that represents an area that an external camera (e.g., camera 312 of FIG. 3) may automatically adjust based on the attention distance d associated with the user attention, according to one or more techniques as discussed herein (e.g., based on convergence angle α). In an exemplary embodiment, the focus element 410 is not directly viewable by the user 102 within each view 400A, 400B, etc., but is illustrated by FIGS. 4A and 4B to represent an area of focus that the camera is adjusted based on the distance of the object within the adjusted focus. For example, view 400A illustrates a change in focus of the view from FIGS. 2A, 2B, as the user 102 has changed his or her attention (e.g., gaze) towards the representation 242 of the second object 142 for a second period of time. Thus, the focus element 410 is centered towards the representation 242 of the second object 142. Moreover, for example, view 400B illustrates a change in focus of the view from FIG. 4A, as the user 102 has changed his or her attention (e.g., gaze) towards the bottom of the representation 232 of the plant 132 (e.g., the base or pot of the plant 132) for a third period of time and thus, the focus element 410 is centered towards the representation 232 of the second object 142.

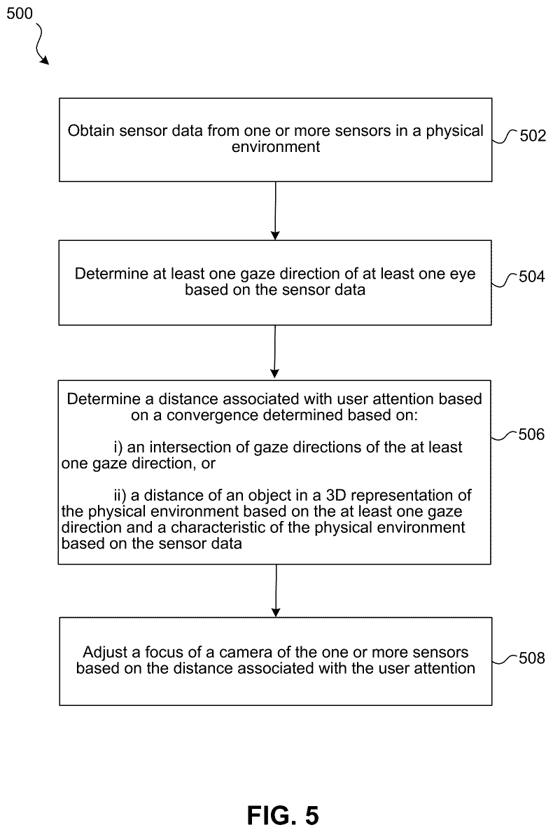

FIG. 5 is a flowchart representation of an exemplary method 500 that that adjusts a focus of a camera based on a determined distance associated with user attention in accordance with some implementations. In some implementations, the method 500 is performed by a device (e.g., device 110 of FIG. 1), such as a mobile device, desktop, laptop, or server device. In some implementations, the device has a screen for displaying images and/or a screen for viewing stereoscopic images such as a head-mounted display (HMD). In some implementations, the method 500 is performed by processing logic, including hardware, firmware, software, or a combination thereof. In some implementations, the method 500 is performed by a processor executing code stored in a non-transitory computer-readable medium (e.g., a memory).

At block 502, the method 500, at an electronic device having a processor, a display, and one or more sensors, obtains sensor data from the one or more sensors in a physical environment. In some implementations, sensor data may include outward-facing sensor data (image, depth, etc.), inward facing sensor data such as eye gaze characteristic data (i.e., gaze convergence), or other sensor data such as motion/pose data. For example, as illustrated in FIG. 1, device 110 obtains sensor data of the user (e.g., physiological data such as eye gaze characteristic data 121 via sensor 120) as well as sensor data of the physical environment 105 (e.g., light intensity image data and depth data via sensors 122, 124, or other sensor data).

At block 504, the method 500 determines at least one gaze direction of at least one eye based on the sensor data. In some implementations, tracking a gaze direction includes tracking a pixel on a display that the gaze is focused upon. In some implementations, a device (e.g., device 110) includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 110 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 110. In some implementations, the at least one gaze direction is determined based on a reflective property (e.g., a spectral property) associated with IR reflections on the at least one eye.

At block 506, the method 500 determines a distance associated with user attention based on: (i) a convergence determined based on an intersection of gaze directions of the at least one gaze direction, or (ii) a distance of an object in a 3D representation of the physical environment based on the at least one gaze direction and a characteristic of the physical environment based on the sensor data. In some implementations, determining a distance associated with user attention may involve fusing different data, e.g., mono gaze vector, depth map data (e.g., passthrough, metric depth, etc.), world/scene understanding, gaze convergence, rendered depth map, and/or UI content data that is displayed to the user.

In some implementations, determining an attention distance d associated with user attention may be based on the convergence angle α 202 determined based on the intersection of the gaze direction. For example, as illustrated in FIG. 2C, as the user 102 directs his left eye gaze 104 and right eye gaze 106 at the first object 140 (or towards the representation 240 of the first object 140 if looking at a 3D representation of the physical environment), and the convergence angle α 202 of the left eye gaze 104 and right eye gaze 106 may be determined in order to determine the focus of the user is upon the first object. Thus, as further described herein, an external camera may automatically adjust the focus of the camera to accommodate to the attention distance d that the user is focused on, thus, when adding virtual content that is placed at that attention distance d, virtual content object would be shown as focused, but if the added virtual content was intended to placed at a different distance than the attention distance d, it may be shown as out of focus of slightly blurred.

In some implementations, determining a distance associated with user attention is based on detecting that a first gaze direction of the at least one gaze direction is oriented towards an object or an area in the 3D representation.

In some implementations, determining a distance associated with user attention is based on different types of data obtained by the one or more sensors. In some implementations, the different types of data may include at least one of gaze vector data, depth map data (e.g., passthrough, metric depth, rendered depth map, etc.), gaze convergence data, user interface content, or a combination thereof. For example, as illustrated in FIG. 3, the sensors 310 may acquire several different types of data that are analyzed by the sensor analysis instruction sets 320 and can be fused in several different combinations by the camera focus adjustment instruction set 370.

In some implementations, determining a distance associated with user attention is based on a scene understanding to identify one or more objects and their positions based on image/depth data, may determine if user is using hands, walking around, and the like. In an exemplary implementation, the user attention is determined by obtaining a scene understanding that identifies one or more objects and positions of the one or more objects within the physical environment, and determining user attention based on a gaze associated with a particular object of the one or more objects within the physical environment. For example, a scene understanding (e.g., determined by scene understanding instruction set 330) may be used to identify one or more objects and their positions based on image/depth data and/or determine a context of the current environment (e.g., what the user is doing in relation to the content being displayed).

In some implementations, determining a distance associated with user attention may be based on obtaining a saliency map or determining a saliency map from the sensor data of the one or more sensor. A saliency map may be an image that highlights a particular region on which people's eyes focus first. In some implementations, a saliency map may be generated based on an analysis of a captured scene to determine a probability that a user will attend to different parts of the environment. Thus, even without monitoring a precise gaze (or even monitoring a gaze at all), the techniques described herein may predict a likelihood that a user is focused at a particular distance and may adjust the camera and or display focus. This technique via a saliency map may be used alone, or in combination with the other signals to improve the confidence of correctly adjusting the focus.

At block 508, the method 500 adjusts a focus of a camera of the one or more sensors based on the distance associated with the user attention. In some implementations, the camera captures image data of the physical environment that is displayed on the display (e.g., pass through video on an HMD).

In some implementations, the display presents an extended reality (XR) environment based at least in part on the physical environment, wherein clarity of virtual content in the XR environment is adjusted to match the image data captured by the camera. For example, once a user attention distance d is determined, virtual content may be generated such that virtual content at the area and distance for the attention distance d will be more clear (e.g., in focus), as opposed to other virtual content that is not close to the depth/distance of the attention distance d associated with the area that a viewer is focused upon.

In some implementations, an identified portion of a view of a 3D environment is an object, such as identifying a viewer is gazing upon the representation 242 of the first object 142. For example, an object detection instruction set may be included that is configured with instructions executable by a processor to analyze sensor data to identify objects. For example, an object detection instruction set can analyze the sensor data (e.g., RGB images, a sparse depth map, and other sources of physical environment information) to identify objects (e.g., furniture, appliances, wall structures, etc.). In some implementations, the object detection instruction set can use machine learning methods for object identification. In some implementations, the machine learning method is a neural network (e.g., an artificial neural network), decision tree, support vector machine, Bayesian network, or the like. For example, the object detection instruction set uses an object detection neural network unit to identify objects and/or an object classification neural network to classify each type of object.

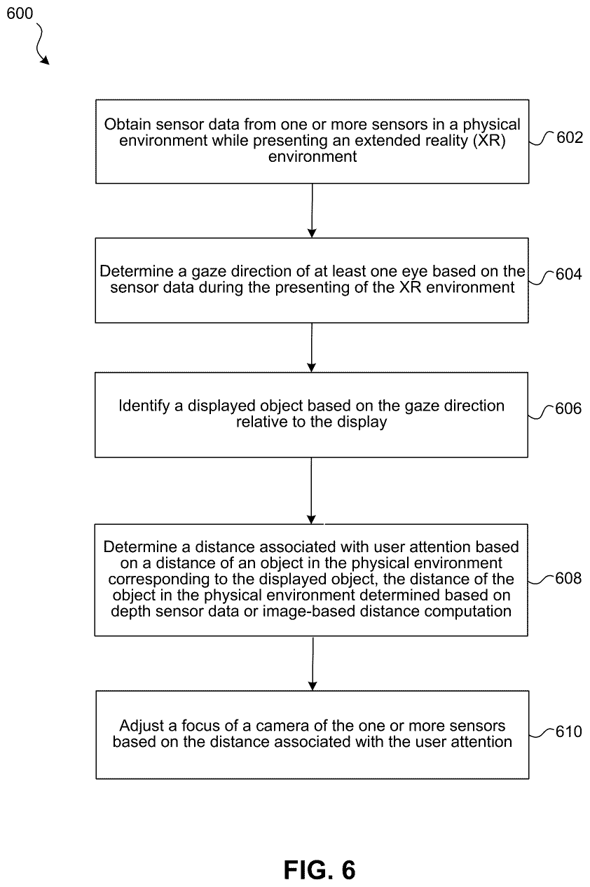

Method 500 provides a process for adjusting focus of an outward-facing camera (e.g., for a head mounted system) based on what an eye is attending to (e.g., focus/vergence) based on an open-loop process, also referred to herein as a “feedforward process”. The open-loop process may focus on a particular object, and have the camera focus at a distance (e.g., user attention distance) based on a depth map and a persistent world model, vergence angles from pupils, etc. This open-loop process may be faster and more efficient for processing and avoid overshoot and focus rocking during the adjustment phase. FIG. 6 illustrates method 600, discussed below, that also provides a process for adjusting focus of an outward-facing camera (e.g., for a head mounted system) based on what an eye is attending to (e.g., focus/vergence), but is based on a closed-loop process, also referred to herein as a “feedback process”. The closed-loop process may adjust a focus of an external camera based on where the user is looking on a display of a head mounted system (e.g., a user attention vector). The closed-loop process may identify a corresponding object and a depth of the corresponding object based on depth sensor data. Thus, as opposed to determining a distance based on focus information provided by the camera itself (e.g., open-loop process of method 500), the closed-loop process may be different than the open-loop process because the closed-loop process is based on where the user is looking on a display (e.g., a user attention vector and a camera focus region of interest), and not based on the camera focus information (e.g., user attention distance and camera focus distance) of the open-loop process of method 500.

FIG. 6 is a flowchart representation of an exemplary method 600 that adjusts a focus of a camera based on a determined distance associated with user attention while presenting an extended reality (XR) environment in accordance with some implementations. In some implementations, the method 600 is performed by a device (e.g., device 110 of FIG. 1), such as a mobile device, desktop, laptop, or server device. In some implementations, the device has a screen for displaying images and/or a screen for viewing stereoscopic images such as a head-mounted display (HMD). In some implementations, the method 600 is performed by processing logic, including hardware, firmware, software, or a combination thereof. In some implementations, the method 600 is performed by a processor executing code stored in a non-transitory computer-readable medium (e.g., a memory).

At block 602, the method 600, at an electronic device a processor, a display, and one or more sensors, obtains sensor data from the one or more sensors in a physical environment while presenting an extended reality (XR) environment. In some implementations, sensor data may include outward-facing sensor data (image, depth, etc.), inward facing sensor data such as eye gaze characteristic data (i.e., gaze convergence), or other sensor data such as motion/pose data. For example, as illustrated in FIG. 1, device 110 obtains sensor data of the user (e.g., physiological data such as eye gaze characteristic data 121 via sensor 120) as well as sensor data of the physical environment 105 (e.g., light intensity image data and depth data via sensors 122, 124, or other sensor data). Further, a view of the XR environment of FIG. 1 is provided in FIGS. 2 and 4. For example, the representations 240, 242, etc., may be added virtual objects, or the entire environment 205 may be a 3D representation of the physical environment 105 (e.g., a simulated virtual scene) as opposed to pass through video of the physical environment 105 (e.g., an HMD that displays the physical environment through a live video feed), or a direct view of the physical environment 105 through transparent lenses (e.g., an HMD that looks like glasses).

At block 604, the method 600 determines a gaze direction of at least one eye based on the sensor data during the presenting of the XR environment. In some implementations, tracking a gaze direction includes tracking a pixel on a display that the gaze is focused upon. In some implementations, a device (e.g., device 110) includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 110 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 110. In some implementations, the at least one gaze direction is determined based on a reflective property (e.g., a spectral property) associated with IR reflections on the at least one eye.

At block 606, the method 600 identifies a displayed object based on the gaze direction relative to the display. For example, based on object detection techniques described herein, the system can determine which displayed object is the user looking at. In some implementations, an identified portion of a view of a 3D environment is an object, such as identifying a viewer is gazing upon the representation 240 of the first object 140. For example, an object detection instruction set may be included that is configured with instructions executable by a processor to analyze sensor data to identify objects. For example, an object detection instruction set can analyze the sensor data (e.g., RGB images, a sparse depth map, and other sources of physical environment information) to identify objects (e.g., furniture, appliances, wall structures, etc.). In some implementations, the object detection instruction set can use machine learning methods for object identification. In some implementations, the machine learning method is a neural network (e.g., an artificial neural network), decision tree, support vector machine, Bayesian network, or the like. For example, the object detection instruction set uses an object detection neural network unit to identify objects and/or an object classification neural network to classify each type of object.

At block 608, the method 600 determines a distance associated with user attention based on a distance of an object in the physical environment corresponding to the displayed object, the distance of the object in the physical environment determined based on depth sensor data or image-based distance computation. In some implementations, a distance associated with user attention based on a distance of an object in the physical environment corresponding to the displayed object may be referred to as a user attention vector (e.g., attention distance d 204 in FIG. 2C). In some implementations, the image-based distance computation may be based on mono or stereo images. In some implementations, determining a distance associated with user attention may involve fusing different data, e.g., mono gaze vector, depth map data (e.g., passthrough, metric depth, etc.), world/scene understanding, gaze convergence, rendered depth map, and/or user interface content data that is displayed to the user.

In some implementations, the distance of the object in the physical environment is determined based on depth sensor data. In some implementations, the distance of the object in the physical environment is determined based on image-based distance computation.

In some implementations, determining an attention distance d associated with user attention may be based on the convergence angle α 202 determined based on the intersection of the gaze direction. For example, as illustrated in FIG. 2C, as the user 102 directs his or her left eye gaze 104 and right eye gaze 106 at the first object 140 (or towards the representation 240 of the first object 140 if looking at a 3D representation of the physical environment), and the convergence angle α 202 of the left eye gaze 104 and right eye gaze 106 may be determined in order to determine the focus of the user is upon the first object. Thus, as further described herein, an external camera may automatically adjust the focus of the camera to accommodate to the attention distance d that the user is focused on, thus, when adding virtual content that is placed at that attention distance d, virtual content object would be shown as focused, but if the added virtual content was intended to be placed at a different distance than the attention distance d, it may be shown as out of focus of slightly blurred.

In some implementations, determining a distance associated with user attention is based on detecting that a first gaze direction of the at least one gaze direction is oriented towards an object or an area in the 3D representation.

In some implementations, determining a distance associated with user attention is based on different types of data obtained by the one or more sensors. In some implementations, the different types of data may include at least one of gaze vector data, depth map data (e.g., passthrough, metric depth, rendered depth map, etc.), gaze convergence data, user interface content, or a combination thereof. For example, as illustrated in FIG. 3, the sensors 310 may acquire several different types of data that are analyzed by the sensor analysis instruction sets 320 and can be fused in several different combinations by the camera focus adjustment instruction set 370.

In some implementations, determining a distance associated with user attention is based on a scene understanding to identify one or more objects and their positions based on image/depth data, may determine if user is using hands, walking around, and the like. In an exemplary implementation, the user attention is determined by obtaining a scene understanding that identifies one or more objects and positions of the one or more objects within the physical environment, and determining user attention based on a gaze associated with a particular object of the one or more objects within the physical environment. For example, a scene understanding (e.g., determined by scene understanding instruction set 330) may be used to identify one or more objects and their positions based on image/depth data and/or determine a context of the current environment (e.g., what the user is doing in relation to the content being displayed).

In some implementations, the user attention is determined based on display characteristics or display settings associated with the display of the electronic device. For example, the display may include a liquid lens or a light field display. In some implementations, the system may analyze display side characteristics or settings for a liquid lens or light field displays. The display side characteristics may include sharpness, A/V conflicts, comfort, and the like. Additionally, or alternatively, in some implementations, other than a liquid lens or a light filed display, other types of focus tuning methods may be utilized on the display side. For example, other focus tuning methods may include moving the panel or lens to change the focus, using a stack of fast switchable lens with a fixed focus, holographic displays, or a combination thereof.

In some implementations, during video playback, identifying a portion (e.g., an object) of the view of a 3D environment may involve determining that the gaze is directed directly towards the portion of the environment. Using gaze detection techniques described herein, a gaze detection system can determine that a user is directly focused on one particular object in a scene that may include multiple objects. For example, a parent may be recording their child playing in a game during capture of the video such that the gaze detection determines that the parent is focused specifically on the child during capture independent of the focus of the camera (e.g., movement of the camera during capture of a live game), and then adjust the focus of the camera specifically on the child.

At block 610, the method 600 adjusts a focus of a camera of the one or more sensors based on the distance associated with the user attention. In some implementations, the camera captures image data of the physical environment that is displayed on the display (e.g., pass through video on an HMD).

In some implementations, a camera controller may be operating in a closed loop mode with a positioning sensor in the camera focus system to help attenuate stimulus from accelerations. For example, accelerations may be detected while a user is walking (e.g., motion detected by an IMU, an accelerometer, or the like), but accelerations (e.g., vibrations) may also be detected from the device itself (e.g., speakers or fans). Thus, the detected accelerations may be used as input data into the control loop process of method 600 as well as the utilization of the detected accelerations for stabilizing focus.

In some implementations, the display presents an extended reality (XR) environment based at least in part on the physical environment, wherein clarity of virtual content in the XR environment is adjusted to match the image data captured by the camera. For example, once a user attention distance d is determined, virtual content may be generated such that virtual content at the area and distance for the attention distance d will be more clear (e.g., in focus), as opposed to other virtual content that is not close to the depth/distance of the attention distance d associated with the area that a viewer is focused upon.

In some implementations, display characteristics may be used to adjust virtual content clarity to match image clarity and/or blur. For example, for both holographic displays and light field displays, techniques described herein can match image clarity and/or blur without tuning. Alternatively, in some implementations, in terms of a display with tunable or switchable lens, if the camera lens is tuned to focus at certain depth such as a close distance, then on the display side the focus may also be tuned to match that close distance that provides a view of the adjusted virtual content with the best sharpness and comfort without conflicting with the audio and/or visual characteristics.

In some implementations, method 500 and/or method 600 may include one or more input methods to determine what an eye is attending to (e.g., focus/vergence) in order to adjust a focus of an outward-facing camera (e.g., for a head mounted system). In some implementations, an input method may include an analysis of a scene of an environment through a depth map, saliency map, and the like. In some implementations, an input method may include sensor data of a user such as tracking gaze, head pose, user motion, etc. For example, the adjusted focus may be based on biasing the focus depending on user behavior (e.g., if the user is walking around, the system may want to bias the focus to a longer distance, or if the user is seated, surrounded by close objects, the system may want to bias closer focus). In some implementations, an input method may be based on the digital content (e.g., rendered content) and/or be application specific (e.g., application specific control of focus). For example, a productivity application, where the user is expected to work with objects close to them (e.g., seated at a desk and using keyboard and mouse) the application behavior may control the focus to be closer, or if the application is an archery application, the system may bias the focus to a further distance). In some implementations, each of these input methods (e.g., scene analysis data, sensor data of a user, rendered content, application specific content, and the like) may be used together to set an ideal focus distance based on all factors, and in some implementations, each input method may have different weightings depending on the use case.

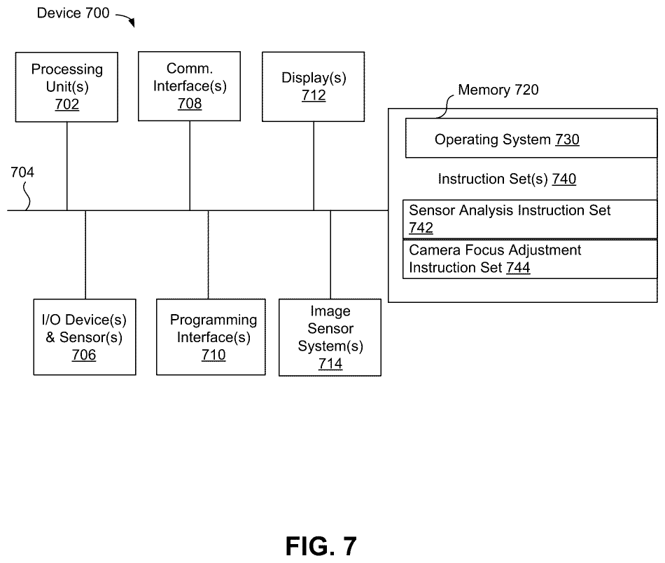

FIG. 7 is a block diagram of an example device 700. Device 700 illustrates an exemplary device configuration for device 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 710, one or more displays 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 712 are configured to present a view of a physical environment or a graphical environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 105. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a sensor analysis instruction set 742 and a camera focus adjustment instruction set 744. The instruction set(s) 740 may be embodied as a single software executable or multiple software executables.

The sensor analysis instruction set 742 is executable by the processing unit(s) 702 to obtain sensor data from the one or more sensors 310 (e.g., light intensity data, depth data, motion data, etc.), obtain content data from a device, and determine sensor analysis information for the device using one or more of the techniques disclosed herein. For example, the sensor analysis instruction set 742 may include subsets of instructions as discussed in FIG. 3, such as a scene understanding instruction set 330, a depth map instruction set 340, a 3D representation instruction set 350, and a physiological instruction set 360. To these ends, in various implementations, the instruction includes instructions and/or logic therefor, and heuristics and metadata therefor.

In some implementations, the camera focus adjustment instruction set 744 is executable by the processing unit(s) 702 to provides a process for adjusting focus of an outward-facing camera (e.g., camera(s) 380 for a head mounted system) based on what an eye is attending to (e.g., focus/vergence) using one or more of the techniques discussed herein (e.g., an open-loop process, a closed-loop process, etc.) or as otherwise may be appropriate. To these ends, in various implementations, the instruction includes instructions and/or logic therefor, and heuristics and metadata therefor.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

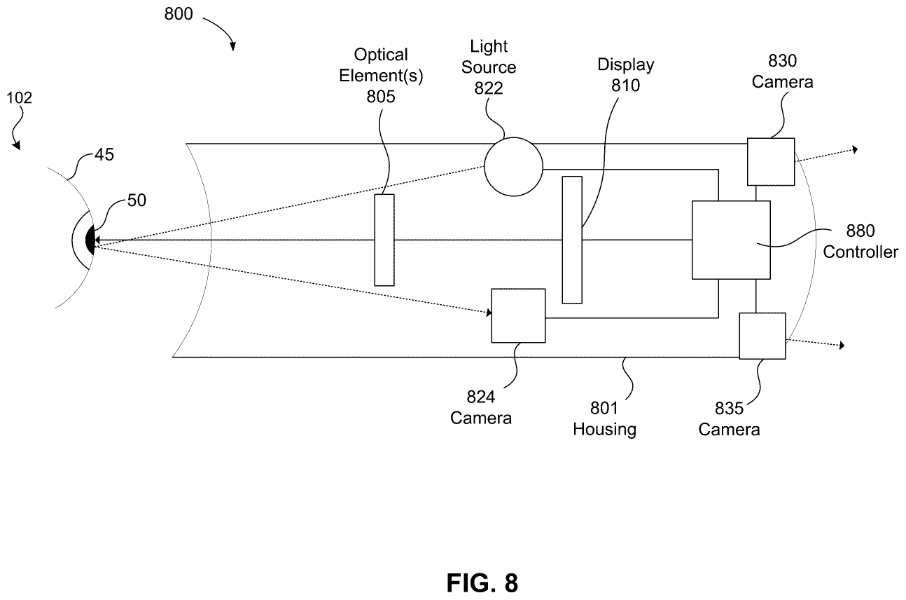

FIG. 8 illustrates a block diagram of an exemplary head-mounted device 800 in accordance with some implementations. The head-mounted device 800 includes a housing 801 (or enclosure) that houses various components of the head-mounted device 800. The housing 801 includes (or is coupled to) an eye pad (not shown) disposed at a proximal (to the user 102) end of the housing 801. In various implementations, the eye pad is a plastic or rubber piece that comfortably and snugly keeps the head-mounted device 800 in the proper position on the face of the user 102 (e.g., surrounding the eye 45 of the user 102).

The housing 801 houses a display 810 that displays an image, emitting light towards or onto the pupil 50 of the eye 45 of a user 102. In various implementations, the display 810 emits the light through an eyepiece having one or more lenses 805 that refracts the light emitted by the display 810, making the display appear to the user 102 to be at a virtual distance farther than the actual distance from the eye to the display 810. For the user 102 to be able to focus on the display 810, in various implementations, the virtual distance is at least greater than a minimum focal distance of the eye (e.g., 7 cm). Further, in order to provide a better user experience, in various implementations, the virtual distance is greater than 1 meter.

The housing 801 also houses a tracking system including one or more light sources 822, camera 824, camera 830, camera 835, and a controller 880. The one or more light sources 822 emit light onto the eye of the user 102 that reflects as a light pattern (e.g., a circle of glints) that can be detected by the camera 824. Based on the light pattern, the controller 880 can determine an eye tracking characteristic of the user 102. For example, the controller 880 can determine a gaze direction and/or a blinking state (eyes open or eyes closed) of the user 102. As another example, the controller 880 can determine a pupil center, a pupil size, or a point of regard with respect to the pupil 50 of the eye 45. Thus, in various implementations, the light is emitted by the one or more light sources 822, reflects off the eye of the user 102, and is detected by the camera 824. In various implementations, the light from the eye of the user 102 is reflected off a hot mirror or passed through an eyepiece before reaching the camera 824.

The display 810 emits light in a first wavelength range and the one or more light sources 822 emit light in a second wavelength range. Similarly, the camera 824 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 810 by looking at it), provide foveated rendering (e.g., present a higher resolution in an area of the display 810 the user 102 is looking at and a lower resolution elsewhere on the display 810), or correct distortions (e.g., for images to be provided on the display 810).

In various implementations, the one or more light sources 822 emit light towards the eye of the user 102 which reflects in the form of a plurality of glints.

In various implementations, the camera 824 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 824 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, head-mounted device 800 includes externally facing sensors (e.g., camera 830 and camera 835) for capturing information from outside of the head-mounted device 800. For example, to capture image data of the physical environment that the user 102 is viewing. The image data can include light intensity image data and/or depth data. For example, camera 830 (e.g., sensor 122 of FIG. 1) may be a video camera for capturing RGB data, and camera 835 (e.g., sensor 124 of FIG. 1) may be a depth sensor (e.g., a structured light, a time-of-flight, or the like) for capturing depth data.

A physical environment (e.g., physical environment 105) refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor, a display, and one or more sensors:
obtaining sensor data from the one or more sensors in a physical environment;
determining at least one gaze direction of at least one eye based on the sensor data;
determining a distance associated with user attention based on:
(a) a convergence determined based on an intersection of gaze directions of the at least one gaze direction, or
(b) a distance of an object in a 3D representation of the physical environment based on the at least one gaze direction and a characteristic of the physical environment based on the sensor data; and
adjusting a focus of a camera of the one or more sensors based on the distance associated with the user attention, the camera capturing image data of the physical environment that is displayed on the display.

2. The method of claim 1, wherein determining the distance associated with user attention is based on the convergence determined based on the intersection of the gaze direction.

3. The method of claim 1, wherein determining the distance associated with user attention is based on detecting that a first gaze direction of the at least one gaze direction is oriented towards an object or an area in the 3D representation.

4. The method of claim 1, wherein determining the distance associated with user attention is based on different types of data obtained by the one or more sensors.

5. The method of any of claim 4, wherein the different types of data comprise at least one of:
gaze vector data;
depth map data;
gaze convergence data; or
user interface content.

6. The method of claim 1, wherein the user attention is determined by:
obtaining a scene understanding that identifies one or more objects and positions of the one or more objects within the physical environment; and
determining user attention based on a gaze associated with a particular object of the one or more objects within the physical environment.

7. The method of claim 1, wherein the at least one gaze direction is determined based on a reflective property associated with infrared (IR) reflections on the at least one eye.

8. The method of claim 1, wherein the display presents an extended reality (XR) environment based at least in part on the physical environment, wherein clarity of virtual content in the XR environment is adjusted to match the image data captured by the camera.

9. The method of claim 1, wherein the electronic device is a head-mounted device (HMD).

10. A device comprising:
one or more sensors;
a display;
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data from the one or more sensors in a physical environment; determining at least one gaze direction of at least one eye based on the sensor data;
determining a distance associated with user attention based on:
(a) a convergence determined based on an intersection of gaze directions of the at least one gaze direction, or
(b) a distance of an object in a 3D representation of the physical environment based on the at least one gaze direction and a characteristic of the physical environment based on the sensor data; and
adjusting a focus of a camera of the one or more sensors based on the distance associated with the user attention, the camera capturing image data of the physical environment that is displayed on the display.

11. The device of claim 10, wherein determining the distance associated with user attention is based on the convergence determined based on the intersection of the gaze direction.

12. The device of claim 10, wherein determining the distance associated with user attention is based on detecting that a first gaze direction of the at least one gaze direction is oriented towards an object or an area in the 3D representation.

13. The device of claim 10, wherein determining the distance associated with user attention is based on different types of data obtained by the one or more sensors.

14. The device of claim 13, wherein the different types of data comprise at least one of:
gaze vector data;
depth map data;
gaze convergence data; or
user interface content.

15. The device of claim 10, wherein the user attention is determined by:
obtaining a scene understanding that identifies one or more objects and positions of the one or more objects within the physical environment; and
determining user attention based on a gaze associated with a particular object of the one or more objects within the physical environment.

16. The device of claim 10, wherein the at least one gaze direction is determined based on a reflective property associated with infrared (IR) reflections on the at least one eye.

17. The device of claim 10, wherein the display presents an extended reality (XR) environment based at least in part on the physical environment, wherein clarity of virtual content in the XR environment is adjusted to match the image data captured by the camera.

18. The device of claim 10, wherein the device is a head-mounted device (HMD).

19. A non-transitory computer-readable storage medium, storing program instructions executable on a device to perform operations comprising:
obtaining sensor data from the one or more sensors in a physical environment;
determining at least one gaze direction of at least one eye based on the sensor data;
determining a distance associated with user attention based on:
(a) a convergence determined based on an intersection of gaze directions of the at least one gaze direction, or
(b) a distance of an object in a 3D representation of the physical environment based on the at least one gaze direction and a characteristic of the physical environment based on the sensor data; and
adjusting a focus of a camera of the one or more sensors based on the distance associated with the user attention, the camera capturing image data of the physical environment that is displayed on the display.

20. The non-transitory computer-readable storage medium of claim 19, wherein determining the distance associated with user attention is based on the convergence determined based on the intersection of the gaze direction.
